(19) United States
(12) Patent Application Publication
(10) Pub. No.: US 2009/0055906 A1
(43) Pub. Date: Feb. 26, 2009

(54) METHOD AND APPARATUS FOR EMBEDDED MEMORY SECURITY

(75) Inventor: Wilhard von Wendorff, Munich (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Infineon Technologies AG, Munich (DE)

(21) Appl. No.: 11/841,171

(22) Filed: Aug. 20, 2007

(51) Int. Cl. G06F 21/22

(52) U.S. Cl. 726/5

(57) ABSTRACT

A method and apparatus for protecting data in a memory block from unauthorized access. When writing or reading data to or from the memory block an error correction code (ECC) is used to calculate an ECC value, wherein the calculation of the ECC value is based on a combination of the data and a password provided to the memory block prior to reading or writing. In case the calculated ECC value does not match a stored ECC value a write or read error is signalled to the device requesting the operation.

### BACKGROUND

This disclosure relates to the field of securing data held in memory of a digital control system, in particular to securing data stored in non-volatile memory against unauthorized access.

Digital control systems include at least one processor and memory for storing data, wherein the processor is the central element of the digital control system. It is the main computing unit of the digital control system executing digital system control algorithms and/or programs defining the system behaviour, wherein the control algorithms and programs configure the processor and include the commands to be executed by the processor. The control algorithms and programs control the processor and thus the digital control system as required by its purpose.

The digital system control algorithms, programs and other data are stored in memory such that the processor can access the data. In the following disclosure, the term data relates to all binary data including executable code or other information like configuration data or settings or the like. In particular, the data are stored at least partially in non-volatile memory, such that the processor can access the data when the system is powered up and the processor must read the data for the first time.

The data as stored in the non-volatile memory has to be protected against unauthorized access for several reasons. One reason is the investment companies have when developing the programs and other data, i.e. the intellectual property in the data must be protected against competitors, which might copy or analyze the data. Furthermore, the system vendors have to prevent the data from being amended for security reasons or for reasons of liability or legal reasons. For example, in an engine management system the data should not be modified in order to increase the combustion engine power, because this may decrease the lifetime of the engine, which is a liability problem, and because the increased power may require a different insurance or a different tax class, which is a legal issue.

Today the problem of securing data in non-volatile memory may be solved, for example, by using one or more passwords allowing access. Additionally, other information such as the origin of an access request may be used for checking the legitimacy of an access. For example, the system may check if the access request originates from the processor or from an on-chip debug unit or from a coprocessor. This type of protection usually is used for accessing a specific memory block of fixed size, i.e. a memory sector. As the password in many cases is a static password, i.e. the password is input once and will not or cannot be changed thereafter, care has to be taken to prevent unauthorized access to the password. Particularly when the password is read from memory and written to the unlock logic the password is prone to unauthorized access. To prevent these specific algorithms implementing a rolling code for a password or an asymmetric code can be used to reduce the risk of password disclosure.

Another conventional method for preventing unauthorized access to memory is to reversibly modify data when writing the data to memory, wherein a signature of the written data is calculated and stored somewhere in a non-disclosed location of the memory. The data stored in memory is then checked periodically against the signature, which can detect the tampered data, but which cannot protect against unauthorized reading the data. Therefore not only a secret algorithm calculates a signature, e.g., a hash, but the data stored in memory is modified directly, i.e. encoded, by a reversible coding algorithm. Accordingly the processor has to decode the data after physically reading from memory before the data can be used in clear text. The apparent drawbacks of this method are the overhead caused by en- and decrypting the data and by periodically checking the integrity of the data using the signature of the data and also the additional extension in hardware for storing the commands for en- and decrypting and for checking the signature.

For these and other reasons there is a need for the present invention.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 depicts a block diagram of a digital processing system according to an embodiment of the invention.

FIG. 2 depicts a table illustrating a manipulation of the password by an error correction code logic.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention will now be described with reference to exemplary embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances well known processes and steps have not been described in detail in order not to unnecessarily obscure the present invention.

In digital control systems various error detection and correction methods are used to detect and, if possible, correct data when reading data from and writing data to memory. That is, when reading data from memory a request is sent from the requesting unit, which may be the central processing unit or another device, e.g., a coprocessor, of the digital control system to the memory or a memory management unit (MMU) via a bus, wherein the request, for example, specifies an address and the amount of data to read from memory. Accordingly, the memory reads the data and performs an error correction code (ECC) on the data read before sending the data out. In case the error correction code does not find an error in the data read or detects and corrects an error, and then the data is sent out to the requesting device and a corresponding signal is sent to the device indicating the success of the read operation. In case the error correction code does find an error in the data read, which cannot be corrected, then the memory signals that an error has occurred. The requesting device in this case will act accordingly, i.e. a central processing unit will stop. In many cases such a read error signal will halt the whole system.

A commonly used technique is an error correction code based on partial parity sums, which will be considered as one example in the following. Note that also other error detection and correction methods/codes may be used. One characteristic of error detection and correction codes is the ability to protect 2^{N}−1 bits, with N being an integer number of correction code bits. Considering the fact that microcontrollers or processors or other units are coupled via busses having widths of 2^{N} bits, an error detection and correction scheme is used that is able to cope with a wider data range than the actual 2^{N} bits. For example, for a data width of 64 bits, i.e. N=6, an error detection and correction scheme for a width of 2⁶=64 bits an error detection and protection scheme covering 2⁶−1=63 is insufficient. Accordingly, a scheme for N=7 will be implemented, which can cope with 2⁷−1=127 bits. That is, the error detection and correction scheme actually implemented can handle a data width significantly wider than needed. In this example the error detection and correction scheme is able to handle a data width, i.e. a data block, of 127 bits length, which extends the required length by 63 bits.

These bits, that the ECC can handle and which exceed the required width, for example the bus width, in one embodiment are used for protecting memory content against unauthorized access as described in the following.

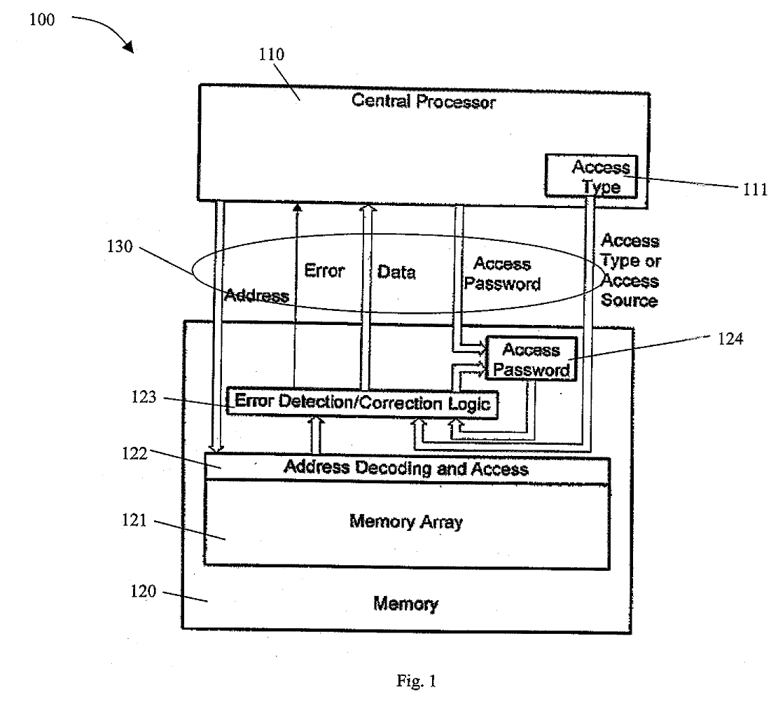

The block diagram 100 as depicted in FIG. 1 illustrates a central processor 110 coupled to a memory 120 by one or more communication links 130. Central processor 110 can be a conventional processor as used in a “system on chip” (SOC) or in a personal computer or in a microcontroller device, which for example is known from the automotive industry for controlling combustion engines. Although not explicitly illustrated in the drawing it is intended that central processor 110 includes further technical sub devices as included in a conventional processor, such as internal registers, ports for sending and receiving data or instructions and a connection to a bus system.

Memory block 120 is intended to include sub devices as included in many conventional memory blocks, although these are not explicitly illustrated for the sake of simplicity. These sub devices, for example, include a connection to a bus system, i.e. a communications link 130, for receiving write or read instructions and for receiving or sending data. Accordingly, memory block 120 includes a connection for coupling to communication link 130. Furthermore, the memory includes memory array 121 coupled to an address decoding and access logic 122, which in turn is coupled to error detection and correction logic 123, and a storage unit 124, which in one embodiment can be written directly via communication link 130, i.e. bypassing the address decoding and access logic 122. In one embodiment, storage unit 124 can be accessed by the error detection and correction logic 123 directly, that is bypassing the address decoding and access logic 122.

Communication link 130 in one exemplary embodiment may be a conventional bus system for coupling a central processing unit (CPU) to a memory block. Alternatively, communication link 130 may be a proprietary communication connection providing the functionality as described in the following.

The direction of data flow as indicated by the arrows relates to an attempt of central processor 110 to read data from memory block 120. Accordingly, the direction of the arrow “data” is reversed when the central processor 110 or any other sub device of the digital processing system writes data.

When reading data from memory 120, central processor 110 provides an access password to memory block 120, which is stored in a storage unit 124, and wherein the password is provided prior to the first read access. Processor 110 also provides further information for reading, such as the address from where to start reading data and how much data to read. As indicated in the drawing, this information is passed to the address decoding and access logic, which will read the requested data from memory array 121 and pass the data to error detection and correction logic 123 (ECC logic 123). ECC logic 123 then reads the access password from storage unit 124 and uses the data read from memory array 121 and the access password for performing the error detection and—if possible—the error correction processes (ECC process). In one example, data read from memory, i.e. a data block of a given size, is concatenated with the password and the ECC processes are performed on this concatenation and the calculated ECC values are compared to the stored ECC values.

If the ECC processes do not reveal an unrecoverable error then a signal indicating the success of the read operation is signalled and the data is sent to central processor 110. Otherwise, if performing the ECC processes indicate an error, then this will be signalled as a read error to the requesting device, i.e. in this example to the central processor, and no data will be sent.

In the above-mentioned example, a bus width of 64 bits and an ECC with N=7 was used, which can cover a block width of 127 bits. Before sending an address together with a read request to memory block 120, central processor 110 will provide an access password of 63 bits to memory block 120, which will be stored in storage unit 124. When the address is received in memory block 120, the address decoding and access logic 122 may accordingly read a block of 64 bits from memory array 121. This data block is passed to ECC logic 123 which accesses and reads the password from storage unit 124. The 64 bits data read from memory array 121 and the 63 bits password are processed together to calculate the ECC values, which will then be compared to the stored ECC values. That is, ECC logic 123 requires the data read from memory array 121 and the password read from storage unit 124 for performing the ECC processes. In one example, the term together is meant to describe that the ECC logic concatenates the data and the password to a block having a length of 127 bits and performs the ECC error detection and correction steps on this 127 bits block. Note that other logical binary operations for combining the password with the data read from memory array 121 may be used. The ECC values as calculated in the ECC method processes are then compared with the stored ECC values, which have been stored when the requested data were written to memory block 120. In case the calculated ECC values match those read from memory, the data and a signal indicating the success of the requested operation are provided to central processor 110. Otherwise, if performing the ECC processes reveals an error, then the error is signalled to the processor and no data is provided. Accordingly, data as requested by central processor 110 is returned only if the correct password is provided before. In case that no password or a wrong password has been provided, no data will be released to processor 110.

In one variation the memory block will signal a read error to the requesting processor 110 in case that no or a wrong password has been provided, but wherein data is provided to the processor. In this case the processor will also halt or the user will receive data with a questionable validity.

In this way a password is provided to the memory block prior to a write data or read data request, an error correction code (ECC) value is calculated based on a combination of the data and the password and the calculated ECC value is compared to an ECC value stored in the memory block. According to the result of the comparison a signal indicating success or error in the operation and data are transferred to the requesting device accordingly.

In a further variation the password may be split up in two portions, which are combined, for example, in the ECC logic to form a single password for use in the ECC logic 123. A first portion may be a password of, for example, 58 bits, which may be user defined and may be an arbitrary password introduced once into central processor 1 10. This password is then stored, for example, in a core register of the processor or in any register, which is hard to detect and to manipulate, such that it is difficult to read and/or manipulate this password portion. The second password portion may have a length of, for example, 5 bits and may be an identifier of the requesting device, for example an identifier of a port 111 requesting a read operation. This information, i.e. an identifier of the device requesting a read or write operation, may be signalled in the request as a sideband signal. The first and second portion of the access password can be processed in various ways to from a single password, for example the first and second portion may be concatenated. In this way the password includes a first portion, which can be arbitrarily chosen und which is stored in a safe place in the system, and a second portion, which identifies the requesting unit of the digital processing system, such that the password reflecting the first and second portion also is used to limit the access to memory to at least one specific device of the system, which must provide the second portion of the password when requesting data operations. It is apparent that the access may also be limited to more than one device, wherein each device must be enabled to provide the second portion of the password to memory block 120.

Note that the password may be split up into more than two portions, such that the access password required for accessing the memory is formed from more than two portions. In one example a first portion may be stored in a register somewhere in the system, a second portion may be used as an identifier of the hardware involved when requesting a data operation, and a third portion may be stored in software executed in the system, such that in this way only a specific software is allowed to access specific data from memory.

Vice versa the process of writing data to memory is performed correspondingly. For example in case that central processor 110 writes data to memory block 120, it has to provide an access password prior to actually sending data to be written to memory, wherein the password will be stored in storage 124. After the access password has been stored in memory block 120, the central processor may send data to the memory block. When memory block 120 receives data in a write request, it reads the access password from storage unit 124 and calculates the ECC values according to the ECC method actually implemented in memory block 120. The calculated ECC values are then stored in memory block 120, i.e. in memory array 121, together with the associated data, such that the ECC values can be read when reading the data later.

The proposed protection scheme furthermore complicates an attack of unauthorized access to memory in that an incorrect password results in a read error signal at the requesting unit, wherein the user or device cannot differentiate between a true read error, i.e. an error when actually reading data from memory array, or an incorrect password. Furthermore error masking may indicate that access is possible only for some memory areas, whereas read errors are signalled when accessing other memory areas. For example if the implemented ECC method is able to detect two bit errors in one block, but can correct only a single bit error, which is also known as double detection single correction, then it may be possible that in case of three bit errors the ECC calculates valid ECC values even if there are actually three bit errors in the processed block of bits. That is the errors accidentally camouflage themselves.

Also more than one access password may be used for protecting memory, such that a plurality of access passwords may be used to protect fragmented areas of memory. Unauthorized access to memory is thus further protected, because in case of an attack the assignments of passwords to memory areas must be known.

FIG. 1 also illustrates the hardware required for executing the proposed method, wherein differences to conventional digital processing systems are apparent. As most of the elements depicted in the drawing are known from conventional systems a description of these is omitted here. For example, a memory block 120 for storing data coupled to a bus system 130 enabling read and write access for data are known from conventional systems, wherein each read or write access involves an ECC logic to check for data integrity when reading and to calculate ECC values when data is written to memory array 121.

In addition to devices included in conventional systems, the memory block 120 may include at least on storage unit 124, in which the access password is stored. The storage unit may be accessed directly from outside, thus bypassing the address decoding and access logic, thus providing direct access to storage unit 124 to any sub device of the digital processing system, which may request to read or write data. Storage unit 124 may be directly accessible by block 123, such that for reading an access password address decoding and access logic 122 is bypassed thus accelerating this read process. Furthermore, storage unit 124 may be coupled to ECC block 123 for writing in order to enable ECC block 123 to write a modified or corrected or a combination of the at least two password portions to storage unit 124. Storage unit 124 in one example may be a register large enough to store a password. For the above described example the register for example should have a length of at least 63 bits.

Furthermore, the implemented ECC method must be enabled to handle data blocks of the size resulting from combining the actual data as read from memory array 121 and the access password. For the above-described example assuming a data block size of 64 bits and a password length of 63 bits, and wherein the data block and the password are concatenated to one block, the implemented ECC method must be able to calculate ECC values for a data block of 127 bits. In case a password is split up into at least two portions, the memory block 120 must be enabled to process the password portions to form a single password to be stored in storage unit 124. In one embodiment and as illustrated in the drawing processing of password portions, for example, can be implemented in the ECC logic 123. That is different to ECC logic known from conventional system the ECC logic as implemented is capable of processing password portions in order to form a single password, which is then stored in storage unit 124.

Any sub device in the digital processing system requesting data operations on memory 120, i.e. in this example central processor 110, must be adapted to provide a password at least before or at the same time when sending a first read or write request to memory block 120. Depending on the implemented algorithm for providing different passwords, for example, when requesting data from different memory blocks, the central processor must be adapted accordingly to provide the appropriate password more than once at the beginning. In one example, central processor 110 must provide a device, for example a core register, for storing a password or a portion of a password. In case of the above-mentioned splitting of the password, central processor 110 must be adapted to provide or initiate the providing of the required parts of the password to memory block 120. For example, in case that an password portion being an identifier of a requesting unit is a specific port, then central processor 110 must be adapted such that the identifier of that port is sent to memory block 120. In certain embodiments, while a password or password portion is stored for example in a core register, the password or password portion may be stored in any storage accessible by the processor.

In a further exemplary embodiment, error correction for the access password itself is enabled. In the unlikely event that one bit accidentally is flipped while providing the access password to memory block 120 or while the password is stored in its storage unit 124, then the ECC logic 123 will correct this bit, because known ECC methods/codes are capable of detecting and also correcting erroneous bits. It is apparent that more than one bit of a password may be corrected in case that the implemented ECC logic is adapted for that.

In still another exemplary embodiment, the feature of correcting a password by the implemented ECC logic 123 can be used in order to manipulate an access password intentionally. As the calculation of the ECC values is based on the data read from memory array 121 and the access password read from storage unit 124 and the ECC is capable to locate the position of an erroneous bit, the data and the ECC values stored may be used to intentionally manipulate the access password in storage unit 124, such that the corrected/modified password will then serve as a new access password. In this way memory block 120 can modify an initially provided access password once provided from a requesting unit and use the modified access password from that time on.

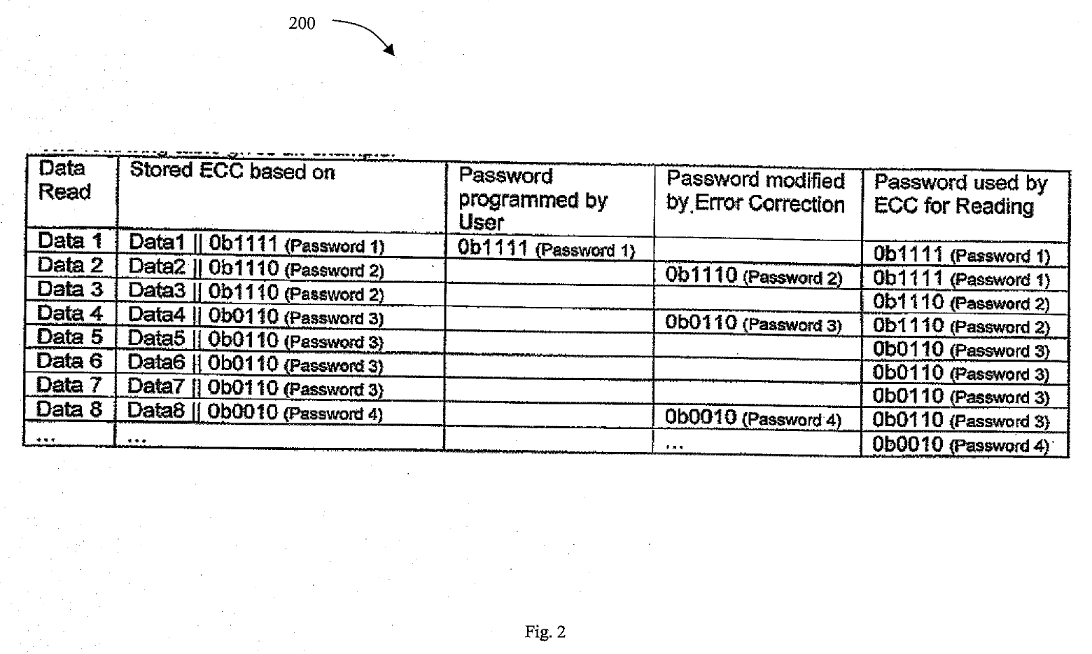

The table as depicted in FIG. 2 depicts an exemplary embodiment of this variation, wherein the table entries illustrate the processing of subsequent read requests. In a first step executed before any data can be read from memory, a password programmed by a user is provided to the memory, wherein the password may be provided in more than one portion as afore mentioned. This initial password may be as given in column “Password programmed by user,” which in this example consists of four bits. This first password is the only one transferred from a requesting device to the memory block and it is transferred only once.

In a next step a requesting sub device requests data from memory block 120. The address decoding and access logic 122 will read Data_1 from memory array 121 accordingly. Data_1 is then passed to the error detection and correction logic 123, which will read the first password Password_1. Note that in column 2 the operator “∥” is used to indicate a concatenation of two data blocks. ECC logic 123 concatenates Data_1 and the initial password as depicted in the first row of column “Stored ECC based on” in order to calculate the ECC value to be compared to the stored ECC value. As the comparison of the calculated ECC value and the stored ECC value do not indicate an error in the first password this remains unchanged. Note that in this case Data_1 may be corrected before transferred to the requesting sub device.

The second column of the table reflects the second read request, in which Data_2 is read from the memory array and Password_1 is used for calculating an actual ECC value. As the stored ECC value is based on a concatenation of Data_2 and a Password_2, which differs in one bit from Password_1, the ECC logic changes the last significant bit of Password_1 and thus amends Password_1 to new Password_2, which is stored in the storage unit to be used as the valid password for subsequent read requests.

In the next read request, i.e. row 3, Data_3 is read from the memory array. ECC logic 123 will concatenate Data_3 with Password_2 and then calculate the ECC value. As the stored ECC value is also based on a concatenation of Data_3 with Password_2 the calculated ECC value matches the stored. Thus there is no correction of Data_3 or of Password_2 when processing this read request.

Subsequently when processing a fourth read request as reflected in row 4 of the table a data block Data_4 is read from memory array 121. Similarly, as described afore, Data_4 is concatenated with Password_2. As the ECC value calculated on this concatenated bit string will differ from the stored ECC value, which is based on a concatenation of Data_4 and a Password_3 differing by one bit from Password_2, the ECC logic 123 will correct, i.e. modify, the differing bit of Password_2. In this way Password_2 is modified to become Password_3. Note that in this particular example only one bit of a password is amended. However as ECC codes may be able to detect and correct 2 or more bit errors the password may be amended also in 2 or more bits.

In this way the error detection and correction logic may be used to intentionally modify the access password when reading and ECC processing data. It is apparent that data stored in the memory array correspondingly must be stored manipulated according to the desired modification of the password. Varying passwords can thus protect the data stored in the memory array. In one embodiment each data read from the memory array may cause an amendment of the password, such that each data is protected by a different password. However a requesting sub device has to provide only the first password for the initial read request. Reading of data is thus limited to a predefined sequence, because the ECC processing of data requires the password as modified in a previous read operation. An attacker trying to read data from memory also must have knowledge of this sequence, which further complicates an unauthorized access to the data.

In another exemplifying embodiment the data stored in the memory array intentionally may include bit errors, which are corrected in the ECC processing before the data is transferred to the requesting unit. Accordingly the data and the associated ECC values must be generated separately and then must be written bypassing the ECC logic included in memory block 120 in order to avoid that the ECC logic 123 processes the intentionally falsified bits in the data and calculates ECC values that cannot be used to correct the data upon reading.

Intentionally falsifying bits in data can be used to further protect the data. That is even if an attacker should manage to read the data from the memory array for example by bypassing the ECC then the data read is falsified and will be useless as the attacker has no information how to correct the data. When the falsified data is read in a regular read request, i.e. when an authorized device requests the data and provides the password, then the ECC processes and corrects the data before transferring these to the requesting device.

Although specific embodiments have been illustrated and described herein, it will be appreciated by those of ordinary skill in the art that a variety of alternate and/or equivalent implementations may be substituted for the specific embodiments illustrated and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for protecting data in a memory block of a digital processing system, comprising:
providing a password to the memory block prior to a write data or read data request;
calculating an error correction code (ECC) value based on a combination of the data and the password, and
comparing the calculated ECC value to an ECC value stored in the memory block.

2. The method of claim 1, wherein the password is split up in at least two portions, the portions being merged to one password in the memory block.

3. The method of claim 2, wherein one portion of the password identifies the device in the digital processing system requesting the write or read data request.

4. The method of claim 1, wherein the device requesting the write or read data request provides the password to the memory block.

5. The method of claim 4, wherein the requesting device writes the password to the memory block bypassing a regular address decoding logic.

6. The method of claim 1, wherein the combination of the data and the password is one of a concatenation or a binary OR or a binary AND or a binary XOR operation or a combination of these operations.

7. The method of claim 1, wherein the ECC logic modifies the data in case of mismatch between a calculated and a stored ECC value.

8. The method of claim 7, wherein a mismatch between a calculated ECC value and a stored ECC value causes the ECC logic to modify the password and wherein the modified password is used as valid password in at least one subsequent read data operation.

9. The method of claim 8, wherein the password is modified in each read data operation.

10. The method of claim 1, wherein the digital processing system is included in an engine management system.

11. A digital processing system comprising:
at least one device requesting write data or read data requests via a communication link from a memory block,
wherein the memory block includes a storage unit for storing a password; and
an error correction code (ECC) logic, wherein the ECC logic is adapted to calculate an ECC value based on a combination of the data and the password.

12. The system of claim 11, wherein the ECC logic is adapted to directly read and write the password to the storage unit bypassing an address logic.

13. The system of claim 11, wherein the device requesting the read or write operation includes a device for storing the password.

14. The system of claim 13, wherein the device for storing the password is a core register in a central processing unit included in the system.

15. The system of claim 11, wherein the device requesting the read or write operation is adapted to provide an identifier identifying the device as a first portion of the password to the memory block and at least a second portion of the password.

16. The system of claim 15, wherein the memory block is adapted to merge the at least two password portions into one password.

17. The system of claim 16, wherein the merge operation is one of a concatenation or a binary AND or a binary OR or a binary XOR operation.

18. The system of claim 11, wherein the ECC logic is adapted for modifying the password in case of a mismatch between a calculated ECC value and a stored ECC value.

19. A digital processing system comprising:
at least one device requesting write data or read data requests via a communication link from a memory block;
wherein the memory block includes a storage unit for storing a password; and
means for calculating an error correction code (ECC) value based on a combination of the data and the password.
